(19) United States
(12) Patent Application Publication
(10) Pub. No.: US 2026/0311415 A1
(43) Pub. Date: Oct. 8, 2026

(54) COLLABORATIVE TEXTURE FILTERING

(71) Applicant: NVIDIA Corporation, Santa Clara, CA (US)

(72) Inventors: Bartlomiej Wronski, Brooklyn, NY (US); Johan Pontus Ebelin, Skåne (SE); Matthew Milton Pharr, Oakland, CA (US); Tomas Guy Akenine-Möller, Lund (SE)

(21) Appl. No.: 19/331,040

(22) Filed: Sep. 17, 2025

Related U.S. Application Data
(60) Provisional application No. 63/785,449, filed on Apr. 8, 2025.

(51) Int. Cl. G06T 15/04; G06T 1/20; G06T 5/20

(52) U.S. Cl. CPC G06T 15/04; G06T 1/20; G06T 5/20

(57) ABSTRACT

Systems and methods are disclosed related to collaborative texture filtering. In at least one embodiment, in a graphics processing unit (GPU) executes a plurality of processing threads organized into waves. In at least one embodiment, redundant texel fetches are identified and one or more threads are reassigned to fetch unique texels through collaboration.

### CLAIM OF PRIORITY

This application claims the benefit of U.S. Provisional Application No. 63/785,449 (Attorney Docket No. 515443) titled “Collaborative Texel Fetching for Stochastic Texture Filtering,” filed Apr. 8, 2025, the entire contents of which is incorporated herein by reference.

### TECHNICAL FIELD

At least one embodiment pertains to computer graphics. For example, at least one embodiment, pertains to a graphics processing unit (GPU) executing a plurality of threads organized into collaborating sets of threads for texture filtering according to various novel techniques described herein.

### BACKGROUND

Stochastic texture filtering (STF) techniques have been developed to address the computational constraints of conventional texel filtering by reducing the number of texel evaluations per pixel. While these methods can reduce computational overhead, they often introduce visual artifacts, noise, and quality degradation, particularly for texture magnification. Newer approaches, such as wave communication STF may also suffer from inefficient resource utilization within GPU execution models, where parallel processing units may perform redundant computations and memory accesses or fail to effectively share results. These limitations create a need for improved texture filtering methods that can maintain high visual quality while operating within the computational constraints imposed by modern texture compression formats. There is a need for addressing these issues and/or other issues associated with the prior art.

### BRIEF DESCRIPTION OF THE DRAWINGS

The present systems and methods for collaborative texture filtering are described in detail below with reference to the attached drawing figures, wherein:

FIG. 1A illustrates a comparison of a magnified filtered texels, according to at least one embodiment.

FIG. 1B illustrates a conceptual diagram of collaborative texture filtering, according to at least one embodiment.

FIG. 1C illustrates box sampling, according to at least one embodiment.

FIG. 1D illustrates mask sampling, according to at least one embodiment.

FIG. 1E illustrates a bijective function used for mask sampling, according to at least one embodiment.

FIG. 1F illustrates list merge collaboration, according to at least one embodiment.

FIG. 2A illustrates a block diagram of an example collaborative texture filtering unit, according to at least one embodiment.

FIG. 2B illustrates fallback sampling, according to at least one embodiment.

FIG. 2C illustrates per-channel decompression sampling, according to at least one embodiment.

FIG. 2D illustrates decompression sampling with thread reassignment, according to at least one embodiment.

FIG. 2E illustrates a flowchart of a method for collaborative texture filtering, according to at least one embodiment.

FIG. 3 illustrates an example parallel processing unit suitable for use in implementing some embodiments of the present disclosure.

FIG. 4A illustrates an example general processing cluster within the parallel processing unit of FIG. 3, suitable for use in implementing some embodiments of the present disclosure.

FIG. 4B illustrates an example memory partition unit of the parallel processing unit of FIG. 3, suitable for use in implementing some embodiments of the present disclosure.

FIG. 4C illustrates an example of the streaming multi-processor of FIG. 4A, suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

FIG. 6A is a conceptual diagram of a graphics processing pipeline implemented by the PPU of FIG. 4 suitable for use in implementing some embodiments of the present disclosure.

FIG. 6B illustrates an exemplary streaming system suitable for use in implementing some embodiments of the present disclosure.

### DETAILED DESCRIPTION

Systems and methods are disclosed related to collaborative texture filtering. Graphics processing units (GPUs) execute thousands of threads organized into execution groups—often called waves or warps—to perform tasks such as sampling texels, applying filter kernels, and reconstructing filtered color values. In at least one embodiment, a GPU executes a plurality of processing lanes (threads) organized into waves (collaborating sets of threads). During texture magnification, multiple pixels within a GPU wave frequently need access to the same texels for their filtering operations. The collaborative approach may identify these overlapping texel requirements and assign each unique texel evaluation to only one thread. Other threads that need the same texel values may then obtain them through wave communication instructions, eliminating redundant computations that would otherwise occur in conventional per-pixel filtering approaches.

Advances in texture compression, including block-based and neural texture formats, have further complicated the texture lookup pipeline, as custom decompression routines now compete with traditional fixed-function texture units. Together, these developments place increasing demands on the parallel architecture of GPUs and the algorithms responsible for delivering high-quality images under a wide range of viewing and magnification conditions. A wide variety of real-time applications, from game engines and virtual reality systems to cloud-streamed rendering services, rely on texture filtering techniques that balance performance, memory bandwidth, and visual fidelity. High magnification scenarios—such as zooming in on a surface or viewing near-plane geometry—are particularly challenging because they demand many texel evaluations per pixel to avoid aliasing and maintain sharpness. At the same time, limited on-chip resources and texture cache capacity create pressure to minimize redundant decompression and minimize the number of texel fetches per frame.

Conventional texture mapping typically performs per-pixel filtering by independently evaluating all of the texels required for each pixel's filter footprint. While these methods are straightforward to implement, they can introduce significant computational overhead and memory traffic. Stochastic filtering techniques reduce the number of texel lookups by probabilistically selecting subsets of texel samples, but they often produce visible noise, aliasing artifacts, and temporal instability under magnification.

Conventional stochastic texture filtering introduces randomness into the texel sampling and/or filtering. Instead of computing a closest texel for the texture coordinates, randomness is introduced by stochastic sampling to obtain one texel. Stochastic sampling may also be applied for filtering the texels when multiple samples are used and/or to perform temporal filtering. A first technique is used for discrete filters and filter-specific sample weights are generated. In contrast with conventional techniques, the sample weights are not applied directly to the single texel value. The single texel is randomly selected for each pixel, with probability proportional to an associated sample weight. A second technique is used for continuous filters and weights are not generated. Instead, the texture coordinates are perturbed with a random offset, which is drawn from a filter-specific probability distribution. While stochastic texture filtering can reduce computational cost, it often does so at the expense of image quality and efficient hardware utilization, especially in scenarios involving texture magnification or complex filter kernels.

More recent wave-level communication schemes leverage on-chip characteristics to share texel values among threads, reducing cache pressure and redundant fetches. However, these techniques can fail to fully exploit available parallel resources and may still perform duplicate texel fetches or redundant computations. In particular, when texel filter footprints overlap heavily during magnification, parallel processing units may perform the same decompression or memory access multiple times. In contrast, collaborative texture filtering reduces duplicated fetches and computations, makes efficient use of decompression resources, and maintains high visual quality under demanding magnification and/or compression constraints.

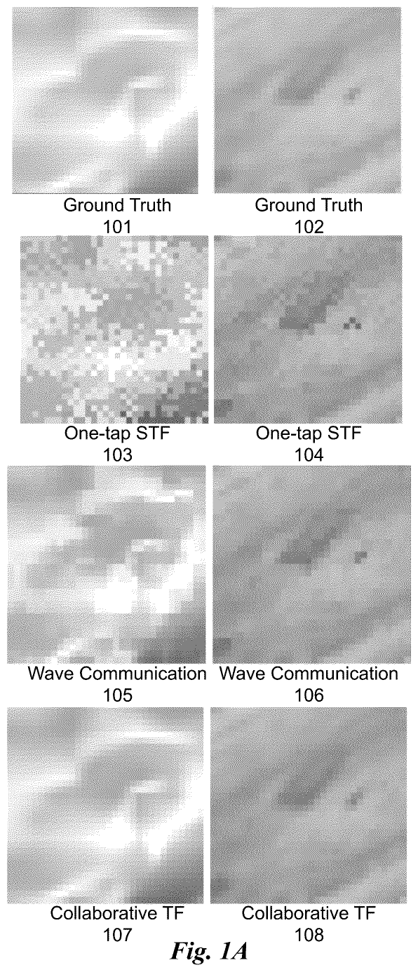

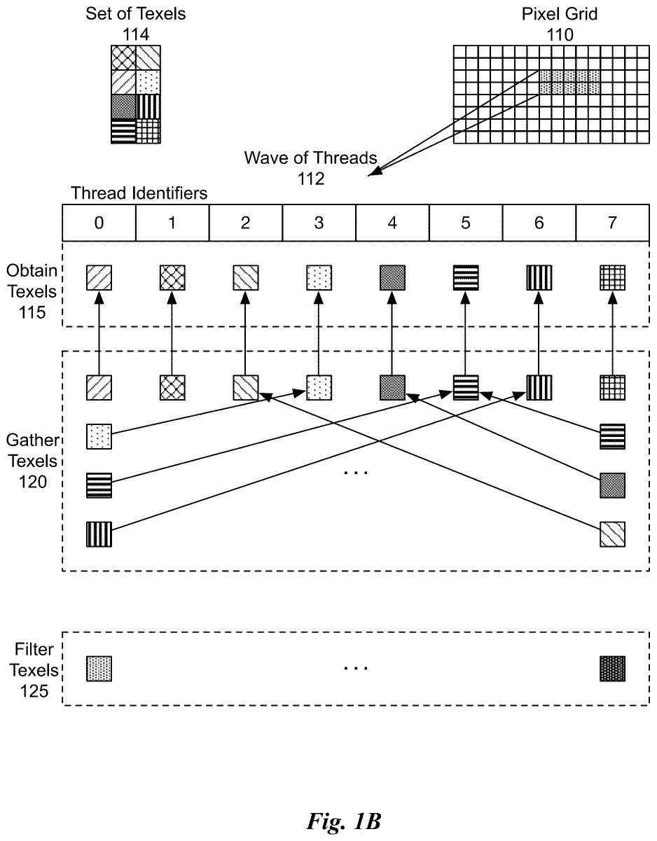

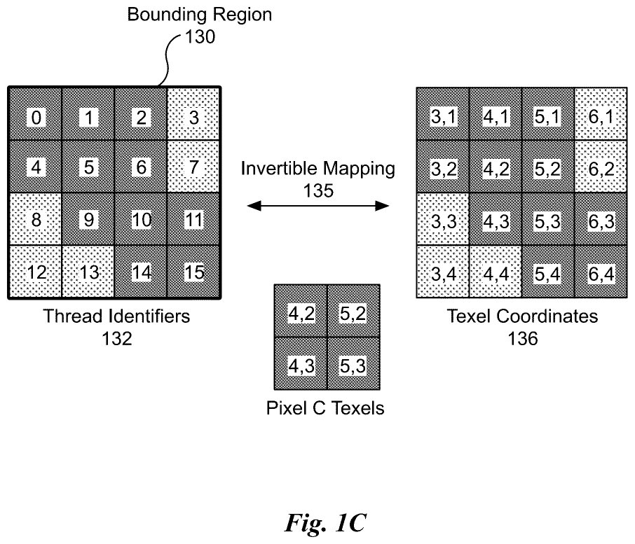

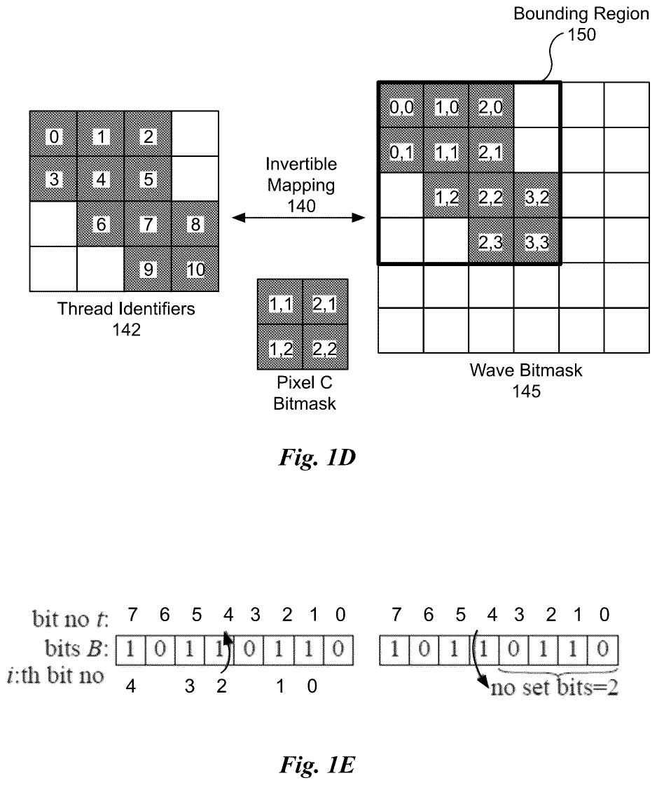

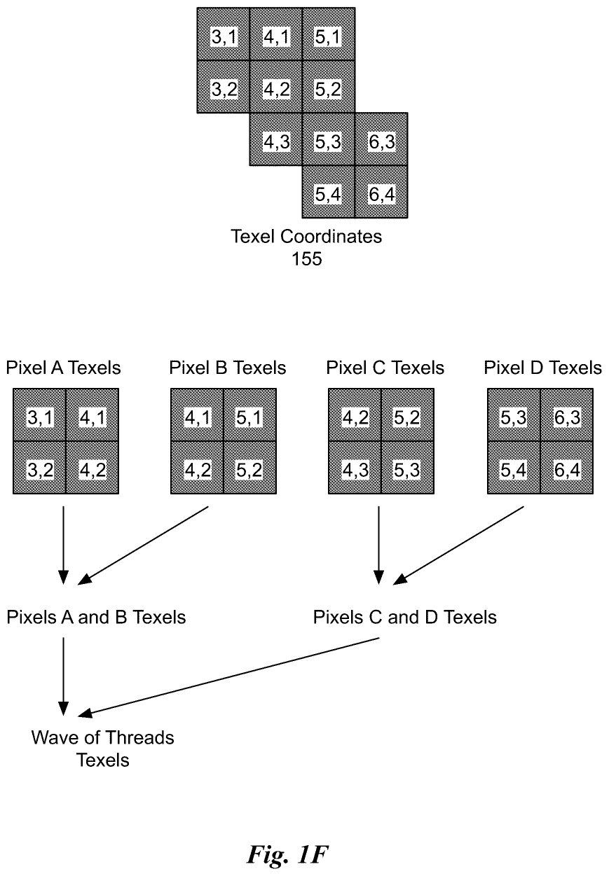

FIG. 1A illustrates a comparison of a magnified filtered texels, according to at least one embodiment. Ground truth 101 is a magnified painted concrete surface texture and ground truth 102 is a magnified brick and mortar texture. Magnification factors range from ~0.0 to 9.1 within the images. Using conventional one-tap STF to compute the bilinearly filtered texel values reduces the image quality, as shown in one-tap STF 103 and 104. Image quality is improved by using wave communication STF instead of conventional one-tap STF, as shown in wave communication 105 and 106. However, using collaborative texture filtering (TF), as shown in collaborative TF 107 and 108 results in image quality that is closest to the ground truth 101 and 102, respectively. The images may be denoised using DLSS (deep learning super sampling) to improve quality-particularly for the one-tap STF and wave communication STF techniques, where, as opposed to the TF results, there was large room for improvement in these examples.

For high magnification factors, only a few texels may be required by all pixels (threads or lanes) in a wave. In at least one embodiment, collaborative texture filtering ensures that all pixels have all texels needed for filtering and performance is improved when computations for texel evaluation are split across multiple threads and performed in parallel. When textures are magnified, sets of pixels communicate to determine their collective texel requirements and then ensure that each pixel fetches or obtains a unique texel. Each pixel then gathers the texels needed for filtering from one or more other threads in the wave. In at least one embodiment, the texels are gathered using efficient wave-intrinsic instructions. For moderate magnification (1.59× or 2.35×, depending on which sampling mode is used) or greater magnification with 32-thread waves, collaborative texture filtering typically has all the texels required for perfect bilinear filtering. For lower magnification factors or with wider filters that require more texels, all texels may not be available. In this case, each pixel can prioritize texels based on their contribution to its filtered result, similarly to wave communication STF. However, for such cases the texel values are combined in a way that improves image quality compared to one-tap STF and wave communication STF, with negligible additional computational cost.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 1B illustrates a conceptual diagram of collaborative texture filtering, according to at least one embodiment. Pixel grid 110 represents a set of pixels that require texture filtering. In the context of the following description, bilinear filtering is used, but as we will show later on, it also extends to arbitrary filters, e.g., bicubic B-spline and Catmull-Rom. Each pixel in the grid corresponds to a thread in a wave of threads 112. A wave of threads 112 is a group of threads (e.g., 8 threads in this example) that operate collaboratively to perform texture filtering. Each thread is associated with a distinct thread identifier, ranging from 0 to 7 in this example. In at least one embodiment, each wave has 32 threads and is configured as 8×4 pixels. However, the algorithms may be used for any wave size and may produce even better results at lower magnification factors with larger waves. In at least one embodiment, the algorithms provide all the texels required for perfect, i.e., with zero error, filtering with at most one texel evaluation per thread for all the threads in a wave.

A texel filter footprint defines a region of texels in texture space required for filtering the 10 shaded pixels in pixel grid 110 and defines set of texels 114 including 8 texels. In at least one embodiment, for bilinear filtering, a 2×2 region of texels is filtered to produce a filtered texel for each pixel. Each thread identifies the texels within set of texels 114 that are necessary to compute the filtered texel value for the pixel associated with that thread. Even for filtering modes, such as bilinear that typically require multiple texels to generate a filtered texel, when collaborative texture filtering is used, only one texel value is fetched by each thread to generate the filtered texel by combining multiple texel values.

The collaborative texture filtering process for each thread in the wave of threads 112 is divided into three main stages: obtain texels 115, gather texels 120, and filter texels 125. Based on texel (u, v) coordinates for each pixel and a filtering mode, each thread identifies the texels (per-thread texels) needed to produce a filtered texel. Using the per-thread texels, a set of texels is collaboratively determined that is needed, where each texel contributes to at least one filtered texel in a set of filtered texels for the pixels. Each thread is associated with a unique texel in the set of texels so that no texel is obtained by more than one thread. In an embodiment, each thread obtains one texel for zero-error texture filtering. The threads in the wave of threads 112 collaborate to identify any duplicate texels in the set of texels that are assigned to two or more threads. In at least one embodiment, at least one thread associated with the duplicate texel is assigned to another texel (not already assigned to a thread) so that each thread is assigned to obtain a unique texel in the set of texels.

As shown in FIG. 1B, collaboration ensures that threads obtain distinct texels across the wave, avoiding redundant texel fetches. For example, during a first stage-obtain texels 115, thread 0 may fetch a specific texel, while thread 1 fetches a different texel, and so on. In at least one embodiment, the number of texels Nin set of texels 114 may be less than the number of threads Tin the wave and the T-N excess thread(s) will not obtain a texel. When the number of texels in the set is greater than the number of threads in the wave (T<N), a fallback mechanism based on one-tap STF is used to compute the filtered texels. In at least one embodiment, the fallback mechanism is based on wave communication STF. In at least one embodiment, when T≤N even after any duplicate texel(s) are removed from the set of texels, only T texels are obtained and N-T texels that are needed are missing.

The threads in the wave obtain (fetch) the texels in the set to complete obtain texel 115. In an embodiment, the threads read the texels from memory to obtain corresponding texel values. In at least one embodiment, the texels are represented in a compressed format and the threads decompress the texels to obtain the texel values. In at least one embodiment, texel values are obtained through procedural generation by evaluating a texel function. In at least one embodiment, a data structure is traversed to obtain the texel values. After the texel values are obtained during obtain texel 115, during the second stage-gather texels 120, each thread gathers any texel values needed to compute the thread's filtered texel that were obtained by other threads.

In other words, the threads collaborate to share the texel values necessary for filtering. Each thread gathers the texel values required for the filter footprint of its associated pixel. For example, thread 0 may gather texels (texel values) from threads 3, 5, and 6 to complete the filter footprint associated with its pixel. Similarly, thread 7 may gather texels from threads 2, 4, and 5 to complete the filter footprint associated with its pixel. In an embodiment, the texel values are stored in registers and each register may be simultaneously read by multiple threads. In an embodiment, the texel values are stored in a local memory that is shared by the threads.

In at least one embodiment, sharing is facilitated by wave communication instructions, which enable threads to exchange data in an efficient manner without accessing off-chip memory. In at least one embodiment, wave intrinsics are used to organize texel gather requests rather than sharing through group shared or off-chip memory. Therefore, high performance can be achieved without requiring shaders to finish or synchronize execution before launching a separate set of shaders to process requests. A characteristic of the collaboration is that each pixel does not necessarily compute a texel value that it needs itself.

Once all the required texel values are gathered, in a third stage-filter texels 125, each thread applies filter weights to compute the filtered texel value for the corresponding pixel. The weights are determined based on the filter mode (e.g., bilinear, bicubic) and the texture coordinates. In an embodiment, the filtering mode comprises one of bilinear, bicubic B-spline, Catmull--Rom, a cubic B-spline polynomial, Mitchell polynomial, Gaussian, parametric, or program. In an embodiment, each weight may be positive or negative. The filtered texel values are subsequently utilized to render the resulting image. Overall, the collaborative approach minimizes redundant texel fetches and reduces memory bandwidth usage, leading to improved performance and higher image quality. By leveraging the wave's parallel processing capabilities and collaboration, all pixels in the wave can access the texels needed for accurate filtering.

The set of texels may be determined using a variety of techniques including, without limitation, box sampling, mask sampling, and list merge. Each technique has different qualities, such as performance and success rate of perfect filtering. FIG. 1C illustrates box sampling, according to at least one embodiment. The box sampling mode selects all texels within a bounding region. As shown in FIG. 1C, bounding region 130 comprises an axis-aligned bounding box (AABB) based on the texture filter footprint and texture coordinates 136 associated with the pixels being processed. Bounding region 130 is defined by the minimum and maximum texel coordinates 136 required by the threads in the entire wave.

Each texel is represented by one of 16 grid cells within bounding region 130. Each texel is assigned to one of T=16 threads and thread identifiers 132 are shown in the texel grid cells within bounding region 130. Texel coordinates 136 for each texel are shown within each grid cell on the right. Darker shaded grid cells associated with thread identifiers 0, 1, 2, 4, 5, 6, 9, 10, 11, 14, and 15 are texels that contribute to at least one filtered texel and lighter shaded texels associated with thread identifiers 3, 7, 8, 12, and 13 are not needed to compute any filtered texels. Each thread calculates an axis-aligned bounding box (AABB) of the texels it needs for texture filtering. The size of the per-thread AABB depends on the texture filtering mode. For example, bilinear filtering uses 2×2 texels bicubic filtering uses 4×4 texels. In at least one embodiment bounding region 130 is determined using the per-thread AABBs for the wave. In at least one embodiment, the bounding region 130 is computed using the WaveActiveMin( ) and WaveActiveMax( ) intrinsics.

Pixel C texels, shown as a subset of the texel coordinates 136, illustrate the specific texels required for bilinear filtering. In this example, the texels having coordinates (4,2), (5,2), (4,3), and (5,3) are the texels contributing to the filtering operation for Pixel C. These texels are gathered from the threads (thread identifiers 5, 6, 9, and 10) responsible for obtaining them, ensuring that all required texel values are available for accurate filtering. While no duplicate texels are obtained, the threads corresponding the thread identifiers 3, 7, 8, 12, and 13 obtain texels that are not needed, i.e., do not contribute to a filtered texel for a pixel.

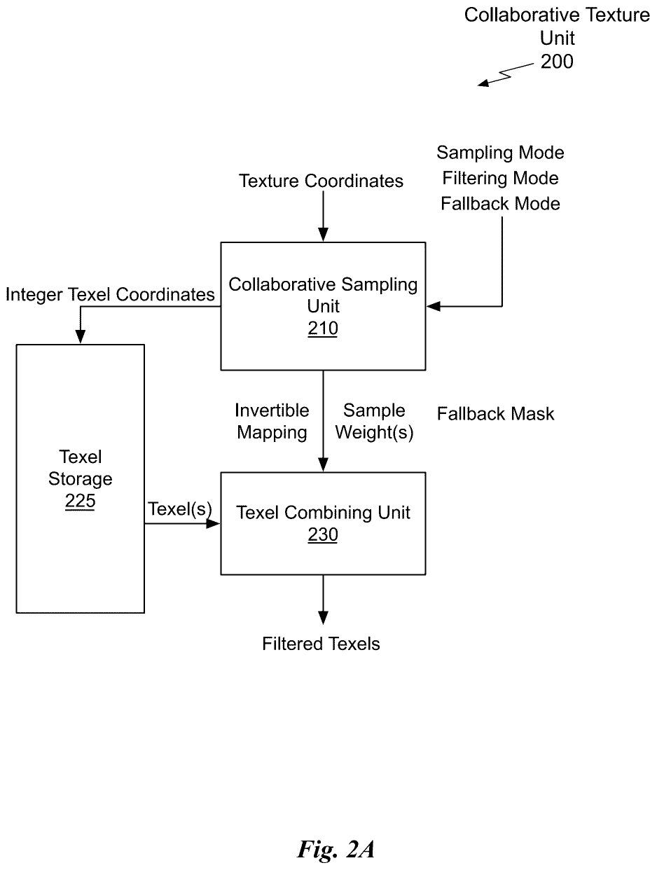

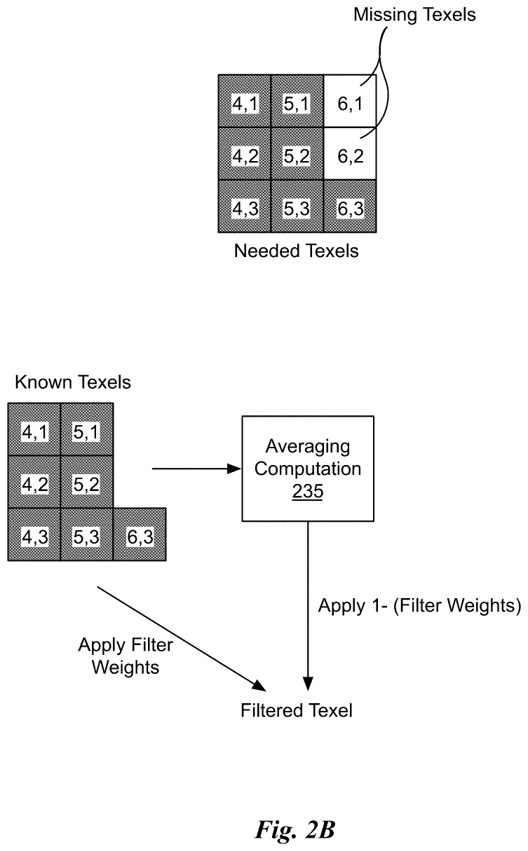

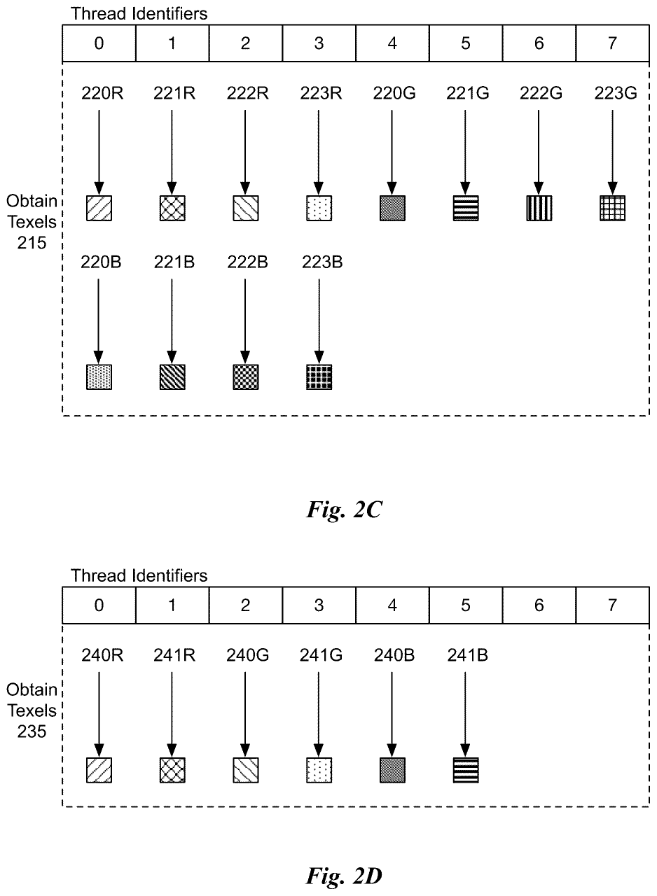

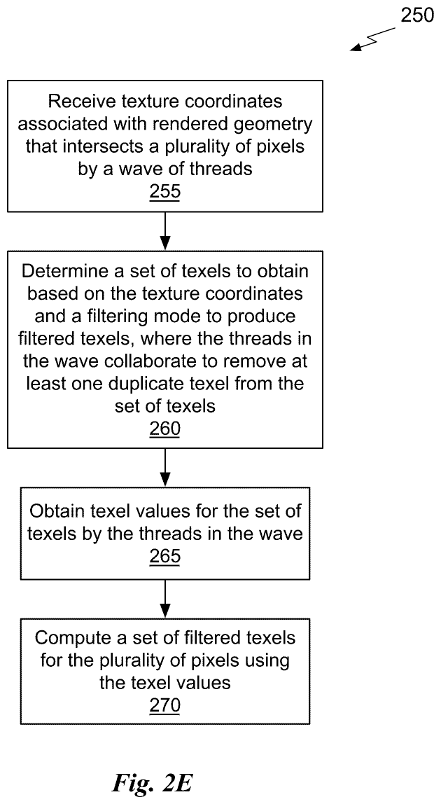

If the area n (number of grid cells n=16) of the bounding region 130 exceeds the number of threads in the wave T, one of the fallback methods described in conjunction with FIG. 2B is used to obtain, gather, and filter the texels. Otherwise, in cases where n does not exceed T, a simple bijective function is used to map from the thread identifier 132 within bounding region 130 to texture coordinates 136. The bijective function is used to generate invertible mapping 135 between the thread identifiers 132 and texel coordinates 136. Invertible mapping 135 may be used by each thread to obtain a texel value and gather the texel values obtained by other threads in the wave. In at least one embodiment, the bijective function uses modulo and division by a width of bounding region 130 to generate invertible mapping 135. Each thread with an index <n uses invertible mapping 135 to obtain the corresponding texel.

Invertible mapping 135 establishes a bijective relationship between the thread identifiers 132 and the texel coordinates 136. The mapping ensures that each thread is associated with a specific texel within the bounding region 130 in a one-to-one manner. For example, thread 0 is mapped to texel coordinate (3,1), thread 1 to (4,1), and so on. Invertible mapping 135 is computationally efficient, allowing threads to quickly determine their assigned texel coordinates 136 based on their thread identifier 132. Similarly, the mapping can be reversed, enabling the retrieval of the thread identifier 132 associated with a given texel coordinate 136. This bidirectional mapping plays a significant role in collaborative operations, such as gathering texel values from other threads in the wave. In at least one embodiment, WaveReadLaneAt( ) instructions are used with the source thread identifier computed through inverse mapping 135 from local coordinates inside bounding region 130 to gather the texels needed for its filter and weight the texel values to generate a perfectly filtered value for the pixel associated with the thread. Overall, box sampling attempts to reduce redundant texel fetches, reduces memory bandwidth usage, and ensures that all threads collaborate efficiently to achieve high-quality texture filtering.

However, while box sampling is simple to implement and fast to execute, a bounding region 130 may include many unnecessary texels, such as texels with coordinates (3,3), (3,4), (4,4), (6,1), and (6,2) in the example shown in FIG. 1C. The number of unnecessary texels is typically higher under perspective projection or rotations around 45 degrees of texture space relative to pixel space, resulting in more frequent need of the fallback method and thus increased error. Mask sampling is a slightly more complex hybrid technique that increases the number of perfectly filtered waves without being as complex as list merging which is described in conjunction with FIG. 1E.

FIG. 1D illustrates mask sampling, according to at least one embodiment. Similar to box sampling, mask sampling starts by creating a bounding region based on the texel integer coordinates and filtering mode. Texels in the set of texels that are within the bounding region and are therefore needed, have shaded grid cells in FIG. 1D. In this example, the set of texels includes N=11 texels. Thread identifiers 142 within a 4×4 wave of threads (T=16) that are assigned to the set of texels are shown as 0, 1, 2, 3, 4, 5, 6, 7, 8, 9, 10. A binary wave bitmask 145, indicates the selected bits that are within the texture footprint within bounding region 150 so that only texels which contribute to filtered texels have their mask bit set. The mask bits are shown in the shaded grid cells within bounding region 150 that are associated with the needed texels in the set of texels. In at least one embodiment, no duplicate texels are obtained and no unneeded texels are obtained. As shown in FIG. 1D, the 36 mask bits are available to represent wave bitmask 145. In at least one embodiment, the wave bitmask corresponds to an 11×11 texel footprint for bilinear filtering and a 16×16 texel footprint for bicubic filtering.

If the number of texels, N in the set of texels is greater than the number of threads in the wave, T, one of the fallback methods described in conjunction with FIG. 2B is used to obtain, gather, and filter the texels. Otherwise, the wave bitmask 145 encodes which texels are needed. In at least one embodiment, the wave bitmask is 16×16 bits and is stored using an uint 64_t4 variable, i.e., 4·64=256=16·16 bits. In at least one embodiment, the wave bitmask is 11×11 bits and is stored using two uint 64_t variable, i.e., 2·64=128>11·11 bits. In an embodiment, when the 256 bit wave bitmask is used, each thread sets the four bits in the wave bitmask corresponding to the 2×2 texels the thread needs for bilinear filtering. Pixel C bitmask includes four texels and the four mask bits are set to 1 (true), specifically the bits (1,1), (2,1), (1,2), and (2,2) corresponding to the same mask bits in the wave bitmask 145. In at least one embodiment, WaveActiveBitOr( ) is applied to the per-thread masks to determine the wave bitmask, B, that contains a 1 for each texel the wave needs for perfect bilinear filtering.

Each texel with a mask bit set is assigned to one of T=16 threads (shown in the left) and only 11 of the 16 threads are assigned. In at least one embodiment, the first 11 threads are assigned to the 11 texels. If i<N, where i is the thread identifier, then the thread will produce a texel. One of the texels marked by a 1 in the wave bitmask is assigned to the thread using the invertible mapping 140.

FIG. 1E illustrates a bijective function t used for mask sampling, according to at least one embodiment. In at least one embodiment, a mapping h is needed from thread identifier i to a requested one-dimensional texel coordinate t in the wave mask, B. In at least one embodiment, h is chosen to map from i to the i^{th} bit that is set in B, and a bijective function t=h(i, B) is used. The number tis in [0,255] and so can be mapped to local two-dimensional coordinates in [0,15] and added to the upper left integer coordinates (0,0) of the bounding region 150. The coordinates are then used to produce the desired texel. In an example, for the thread identifier i=2, then h(2, B)=4 since the bit number of the 2nd set bit is 4, as illustrated by the left arrow. Note that counting starts from 0, so the 0th set bit is at position 1 in the example shown in FIG. 1E. To the right, t=4 is mapped to thread identifier i by counting the number of set bits to the right of t=4. The result is 2, so h⁻¹(4, B)=2. In at least one embodiment, invertible mapping 140 comprises the bijective mapping function t.

After the texels are obtained, each thread assigned to a texel gathers texel values from other threads in the waves and combines the texel values to compute filtered texels. For each two-dimensional texel coordinate needed in by a thread, the corresponding integer coordinate, t, is computed and the corresponding texel is gathered from the thread with thread identifier i=h⁻¹(t, B), where the inverse of finding the ith set bit is counting the set bits below bit t. All the texels needed for the thread are guaranteed to have been produced by the wave, and the texel values are weighted and the perfectly filtered value is returned.

The mask sampling technique minimizes redundant texel fetches by ensuring that each thread fetches a distinct texel. Additionally, the use of wave bitmask 145 reduces memory bandwidth usage by encoding only the necessary texels. Invertible mapping 140 further enhances efficiency by enabling quick and deterministic assignment of texels to threads and gathering of texel values. However, invertible mapping 140 between the thread identifiers 142 and wave bitmask 145 is more complex compared with invertible mapping 135 for box sampling mapping.

FIG. 1F illustrates list merge collaboration, according to at least one embodiment. List merge creates a list of the unique texels required by the wave. In at least one embodiment, the list is constructed in shared memory using a hierarchical list merge algorithm. The texture coordinates assigned to each thread determine which N×N texels the thread needs for producing its filtered texel. For a bilinear filter with 2×2 texture filtering footprint, the integer coordinates of the four texels are put in a list of length four for each thread identifier.

As illustrated to the left in FIG. 1F, a hierarchical list merge is then performed, using shared memory to store the lists during the merge. Rather than summing two values, two lists are merged such that the list never contains any duplicate texel coordinate pairs. The hierarchical list merge begins with texel coordinates 155, which represent the spatial locations of texels in texture space. The texels are organized into a grid, with each texel identified by the corresponding coordinates. Each pixel corresponding to a thread in the wave requires a specific set of texels for filtering. For instance Pixel A requires texels at coordinates (3,1), (4,1) (3,2), and (4,2), Pixel B requires texels at coordinates (4,1), (5,1), (4,2), and (5,2), Pixel C requires texels at coordinates (4,2), (5,2) and (4,3), and (5,3), and Pixel D requires texels at coordinates (5,3), (6,3), and (5,4), and (6,4). The texels required by each pixel are grouped into subsets: Pixels A and B share overlapping texels, such as (4,1) and (4,2), which are grouped together for collaborative processing as Pixels A and B Texels. Similarly, Pixels C and D share overlapping texels, such as (5,2), (5,3), which are grouped together as Pixels C and D Texels. The lists for the subsets are merged to produce a final list, wave of threads texels.

The final list is checked to see if the number of elements in the list, N (equal to the number of texels in the set of texels) is larger than the number of available threads T. If so, perfect filtering with one texel evaluation per lane is not possible and one of the fallback methods described in conjunction with FIG. 2B is used to obtain, gather, and filter the texels. Otherwise, each thread first produces the texel whose index in the merged list is the same as its thread identifier. After texels have been produced, each thread loops over threads in the wave to gather the texels that fall within its filter footprint and then weights the texels using the original texture filter weights. List merge is an accurate and comprehensive technique for determining the minimal set of texels needed for collaborative texture filtering. While it may be less efficient in terms of runtime compared to either box or mask sampling, it provides optimal texel utilization, eliminates redundant fetches, and provides for perfect filtering via collaboration.

FIG. 2A illustrates a block diagram of an example collaborative texture filtering unit, according to at least one embodiment. The collaborative texture unit includes a collaborative sampling unit 210, texel combining unit 230, and interfaces to a texel storage 225, each of which may be implemented as software, hardware, or a combination. In an embodiment, texel storage 225 is a cache hierarchy backed by a local on or off device memory storage. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the security requirement extraction and analysis system 100 is within the scope and spirit of embodiments of the present disclosure.

Collaborative texture filtering may be implemented within a texture map unit and/or tensor cores and/or by software executed on the GPU. As shown in FIG. 2A, collaborative texture unit 200 receives texture coordinates for a plurality of pixels. The collaborative texture unit 200 computes a filtered texel (color) for each pixel. A sampling mode (box, mask, or list merge) and filtering mode may be specified for each texture map or provided via an instruction. The sampling mode and/or filtering mode may be specified for each texture, object, image, or the like. A fallback mode, described in conjunction with FIG. 2B that is used when N>T may also be specified. In at least one embodiment, for at least one fallback mode, a fallback mask is generated. The fallback methods attempt to allow each thread in the wave do useful work toward increasing the filtering quality.

The sampling mode and filtering mode may contribute to computations of sample weights and integer texel coordinates (for one or more texels per pixel). Collaborative sampling unit 210 computes the integer texel coordinates for each texel according to the filtering mode. The filtering mode may define a filter kernel (e.g., bilinear, bicubic B-spline, Catmull--Rom, a cubic B-spline polynomial, Mitchell polynomial, Gaussian, parametric, or program, etc.). Collaborative sampling unit 210 computes weights for the texels and generates an invertible mapping for the threads. The invertible mapping ensures that each thread in a wave is assigned a distinct texel, minimizing redundant fetches.

Texel storage 225 stores texel data, which may include compressed or uncompressed texel values. Texel storage 225 receives integer texel coordinates from collaborative sampling unit 210 and provides the corresponding texel values to texel combining unit 230. Texel storage 225 may be implemented as a cache hierarchy backed by local or off-device memory, facilitating efficient access to texel data.

Texel combining unit 230 receives the texel values from texel storage 225, along with the invertible mapping, sample weights, and fallback mask (when the fallback mode is used) from collaborative sampling unit 210. When multiple texels (samples) are used to compute the filtered texel for a pixel, the texels are combined using the sample weights to produce a filtered texel for each pixel. In at least one embodiment, the texel values are combined using the sample weights to generate filtered texels.

Collaborative texture unit 200 operates in a highly parallelized manner, leveraging the GPU's wave-level execution model to distribute texel evaluation and filtering tasks across multiple threads. This collaborative approach reduces redundant texel fetches, optimizes memory bandwidth usage, and improves the overall performance and visual quality of texture filtering. By integrating texel storage 225, collaborative sampling unit 210, and texel combining unit 230, collaborative texture unit 200 provides a scalable and efficient solution for texture magnification and other demanding graphics applications.

In at least one embodiment, multiple fallback modes are available including one or more of conventional one-tap STF, wave communication STF, basic (C) and extended (C+), where basic and extended fallback modes may include stochastic and deterministic variants. The fallback modes are used when the number of threads in a wave is insufficient to evaluate all the texels required for filtering. Both modes perform STF filtering. In at least one embodiment, for each pixel, n×m texels contribute to each filtered texel centered at the n×m footprint. For each thread, texel values that are obtained and gathered by the threads in the wave and used to produce the filtered texel are scaled by their corresponding weights and summed to compute a first term. If any of the needed texel values are not available, i.e., were not either obtained or gathered by the thread, the first term is summed with a second term. The second term scales an average texel value by one minus a sum of the missing texel weights. The average texel value is an average of obtained and gathered texel values for the filtered texel. The sum of the first and second terms comprises the filtered texel. The basic method may obtain duplicate texels. The extended method reassigns threads for duplicate texels to additional texels that contribute to at least one filtered texel in the set of filtered texels.

FIG. 2B illustrates fallback sampling, according to at least one embodiment. Each thread starts by computing the coordinates of a texel using STF, i.e., randomly selecting a texel with probability based on its corresponding filter weight to perform a stochastic variant of fallback sampling. For the basic method, all threads produce their corresponding STF texel, gather unique texels belonging to their filter footprints that were obtained by other threads within the wave, and then weight those texels to form the final filtered result. Needed texels in FIG. 2B represents the texels needed for one of the threads to produce a filtered texel. In this example, the needed texels are arranged in a 3×3 grid, with coordinates (4,1), (5,1), (6,1), (4,2), (5,2), (6,2), (4,3), (5,3), and (6,3). These texels define the filter footprint for the pixel being processed. Assuming that the thread obtains a texel with coordinate (5,2) and other threads in the wave gather the other needed texels, except for texels with coordinates (6,1) and (6,2) that are missing texels. The missing texels are those texels from the needed texels that could not be obtained due to thread limitations. The texel values of the obtained and gathered texels are known texels.

Assume that a texel value, pₖ, is produced for the thread corresponding to thread identifier k. Each thread corresponding to thread identifier i identifies N unique texels pᵢ, with nonzero filter weights wᵢ, that contribute to its pixel's filtered value. Then, the thread's filtered value is estimated as

$${c}_{k} = {\sum }_{i = 0}^{N - 1} {w}_{i} {p}_{i} + ( 1 - {\sum }_{i = 0}^{N - 1} {W}_{i} ) \frac{{\sum }_{i = 0}^{N - 1} {p}_{i}}{N} , \qquad ( 1 )$$

where the first term represents the known filtered texel values weighted by their corresponding filter weights. To compensate for the absence of the missing texels, an average of the known texels is computed by averaging computation 235 as

$$\frac{{\sum }_{i = 0}^{N - 1} {p}_{i}}{N} .$$

The unweighted average serves as an estimate for the missing texels and is computed by applying a sum of the filter weights for the known texels subtracted from one to the average. The estimation is unbiased in scenarios where the texture data is smooth or low-frequency, as the average closely approximates the missing values. For the case when only one unique texel is known for the thread corresponding to thread identifier i, a single value pᵢ is returned, which is the same as the classic one-tap STF evaluation. When all texel values necessary for computing the filtered texel by a single thread are known, the second term of the equation is zero and the result is perfect filtering with zero error.

The extended fallback method further improves quality by avoiding duplicate texels when multiple threads select the same texel. To remove the duplicate(s), the set of texels to be obtained is represented using a bitmask, similar to mask sampling. Before the actual STF texel evaluation, each thread sets the bit corresponding to the coordinates of its STF texel. In at least one embodiment, WaveActiveBitOr( ) is used to find a bitmask containing all texels that the wave is set to obtain. Counting the number n of set bits in the bitmask gives the number of unique texels that need to be produced for this initial texel evaluation, which is the number of texels in the set of texels, N. In scenarios where the stochastic or deterministic fallback mode is applied, texel combining unit 230 utilizes the fallback mask to address missing texels and preserve image quality. A difference between the extended fallback method and mask sampling is that only one bit is set per thread to generate the per-thread bitmask for the extended fallback method, rather than generating a multi-bit, e.g., 2×2 per-thread bitmask according to the filtering mode. The remaining T-n threads may select different texels that are not assigned to any other thread in the wave to improve quality. The first n threads each produce their corresponding STF texel. The remaining T-n threads also produce texels, with each of the remaining threads stochastically selecting a texel from its filter footprint that has not yet been produced by any of the first n lanes. The selected texels are spread out evenly over the T threads in the wave. When n<T, a simple mapping is used to distribute sample selection over the remaining threads, i.e.,

$$l = ⌊ \frac{31 ( c - n )}{31 - n} ⌉ , \qquad ( 2 )$$

where l is the resulting thread identifier, c is the current thread identifier, which in the case of the T-n remaining threads must be in [n, T−1], and └·┐ rounds to the nearest integer. The mapping ensures that threads 0 and T−1 are always included when T−n≥2. When only one thread is left, the equation above maps the one thread to l=0. Alternative mappings are also possible. Following assignment of the remaining threads, all threads in the wave obtain a texel, and the filtered texels are as described by Equation 1. The fallback methods are biased, yet they provide superior quality compared to previous, unbiased alternatives. In sum, by leveraging collaborative texel sharing and estimation techniques, the fallback methods attempt to maintain high image quality while incurring but small computational overhead.

In at least one embodiment, deterministic variants of the basic and extended fallback methods may be performed. Instead of using stochastic texels lookups, the texel with the corresponding largest filter weight is selected. For the extended fallback method, each of the 32-n remaining threads select the texel associated with the largest weight among the texels that have not yet been sampled under the pixel's footprint. The deterministic variants may provide better image quality on average, but at a cost of higher bias and sometimes with visible artifacts. Furthermore, the deterministic variants may not converge without camera jitter, but that may not matter much if only one sample per pixel is used.

In an embodiment, the texels are compressed and texel combining unit 230 decompresses the texels that are obtained to produce the texel values. Discrete cosine transform (DCT) compressed texels include compressed channels so that each color channel red, green, and blue (RGB) is decompressed separately. Therefore, the threads may decompress the channels in sequence, with each thread decompressing a first channel in parallel, followed by a second channel, etc. More specifically, when T=8 and N=8, the threads decompress the red channel in a first processing pass, the green channel in a second processing pass, and the blue channel in a third processing pass to obtain 8 texel values. When there are more threads in a wave than needed texels, there is an opportunity to distribute the work required for producing a texel value across multiple threads rather than having a single thread produce each texel value through collaboration, improving performance.

FIG. 2C illustrates per-channel decompression sampling, according to at least one embodiment. Each thread in the wave is assigned to decompress a single color channel of a texel. For example, thread 0 decompresses the red channel of texel 220 (220R), thread 1 decompresses the red channel of texel 221 (221R), thread 2 decompresses the red channel of texel 222 (222R), thread 3 decompresses the red channel of texel 223 (223R), thread 4 decompresses the green channel of texel 220 (220G), thread 5 decompresses the green channel of texel 221 (221G), thread 6 decompresses the green channel of texel 222 (222G), and thread 7 decompresses the green channel of texel 223 (223G). The blue channels of texels 220 (220B), 221 (221B), 222 (222B), and 223 (223B) are decompressed by threads 0, 1, 2, and 3 in a subsequent processing pass. Therefore, two processing passes are needed for obtain texels 215.

FIG. 2D illustrates decompression sampling with thread reassignment, according to at least one embodiment. If a wave needs only two texels, then the texels may be obtained in a single processing pass. More generally, for T threads in a wave, the number of processing passes needed for decompression may be reduced to a single pass when the number of texels needed, N<=floor(T/3). For example, thread 0 decompresses the red channel of texel 240 (240R), thread 1 decompresses the red channel of texel 241 (241R), thread 2 decompresses the green channel of texel 240 (240G), thread 3 decompresses the green channel of texel 241 (241G), thread 2 decompresses the green channel of texel 240 (240G), and thread 5 decompresses the blue channel of texel 241 (241G). Only one processing pass is needed for obtain texels 235. The assignment of threads to specific texel channels ensures that, when possible, all threads in the wave are actively engaged in decompression tasks. This approach minimizes idle threads and maximizes parallelism. Threads collaborate to ensure that the decompression workload is efficiently distributed. The per-channel decompression technique can be extended to accommodate larger waves and more intricate texture formats, making the approach effective for high-performance graphics applications.

With a test scene with a plane viewed at an angle where the per-channel decompression optimization was applicable at roughly half of the pixels, a 1.64× speedup may be achieved. When all pixels had sufficiently large magnification factors, a 2.5× speedup may be achieved. Similar performance improvements may be available for neural compression techniques, where neural network evaluation could be distributed across multiple threads when idle threads are available.

In an embodiment, the texel combining unit 230 includes tensor cores capable of decompressing N(32) texels in parallel for NTC (neural texture compression). The tensor core width may be smaller than N. For example, the tensor core width may be N/2, which means that multiple processing passes are executed by the tensor cores to decompress 32 texels. For example, when N=32 the tensor cores perform two processing passes because 16*2=32.

To gain some performance for NTC and similar techniques, an optimization similar to the DCT decompression described above may be used. If the collaborative sampling unit 210 detects that N<=16 (the tensor core width) texels for a wave, then commands are issued to the tensor cores to run with only 16 elements, which is faster than running a multipass variant with 2 passes and 16*2 in width (and with cores not doing useful work). Collaboration can be used to similarly distribute sampling of different axis-aligned planes between threads in a wave, or, in general, even different material samples.

FIG. 2E illustrates a flowchart of a method 250 for collaborative texture filtering, according to at least one embodiment. Each block of method 250, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 250 is described, by way of example, with respect to the collaborative texture unit 200 of FIG. 2A. However, this method may additionally or alternatively be executed by any one system, or any combination of systems, including, but not limited to, those described herein. Furthermore, persons of ordinary skill in the art will understand that any system that performs method 250 is within the scope and spirit of embodiments of the present disclosure.

At step 255, texture coordinates associated with rendered geometry that intersects a plurality of pixels for processing by a wave of threads are received. At step 260, a set of texels to obtain is determined based on the texture coordinates and a filtering mode to produce filtered texels, where the threads in the wave collaborate to remove at least one duplicate texel from the set of texels. In at least one embodiment, a number of threads in the wave is greater than or equal to a number of texels in the set of texels. In at least one embodiment, the set of texels comprises texels within a bounding region defined by a texture footprint corresponding to the plurality of pixels for the filtering mode. In at least one embodiment, the bounding region is a box defined by minimal texel coordinates and maximum texel coordinates of the texture footprint. In at least one embodiment, the bounding region is defined by a bitmask indicating the set of texels and the bitmask is produced by combining per-thread bitmasks indicating one or more texels needed to compute one filtered texel for each pixel in the plurality of pixels. In at least one embodiment, an invertible mapping is generated between thread identifiers and either the texel coordinates or a wave bitmask. In at least one embodiment, a bijective function is used to generate the invertible mapping. The invertible mapping enables collaboration between the threads for obtaining the texels and/or gathering the texel values.

In at least one embodiment, at step 260 a first thread in the wave of threads corresponding to a duplicate texel is identified, where the duplicate texel is assigned to the first thread and at least a second thread in the wave of threads. In at least one embodiment, the first thread is assigned to a first texel in the set of texels that is not assigned to any of the threads in the wave. At step 265, texel values for the set of texels are obtained by the threads in the wave. In at least one embodiment, each thread in the wave obtains at most one texel. In at least one embodiment, obtain may include, without limitation, reading or fetching a texel value or compressed representation of a texel value from a register, cache, or memory.

At step 270, a set of filtered texels is computed for the plurality of pixels using the texel values. In at least one embodiment, a number of threads in the wave is less than a number of texels in the set of texels. In at least one embodiment, at least one missing texel that contributes to a first filtered texel in the set of filtered texels is not included in the set of texels. In at least one embodiment, the first filtered texel is computed based on an estimated contribution of the at least one missing texel comprising an average of at least one texel value of the texel values (average of known texels). In at least one embodiment, the filtering mode comprises one of bilinear, bicubic B-spline, Catmull--Rom, a cubic B-spline polynomial, Mitchell polynomial, Gaussian, parametric, or program.

In an embodiment, at least one of steps 255, 260, 265, or 270 is performed on a server or in a data center to generate an image, and the image is streamed to a user device. In an embodiment, at least one of steps 255, 260, 265, or 270 is performed within a cloud computing environment. In an embodiment, at least one of steps 255, 260, 265, or 270 is performed for training, testing, or certifying a neural network employed in a machine, robot, or autonomous vehicle. In an embodiment, at least one of steps 255, 260, 265, or 270 is performed on a virtual machine comprising a portion of a graphics processing unit.

In at least one embodiment, collaborative texture filtering provides perfect filtering with small discrete texture filters above modest magnification factors and also with larger texture filters at higher magnification factors. This is a natural outcome, since more texels are needed for larger texture filters. For perfect filtering at lower magnification rates, collaborative texture filtering can be extended to generate more than one texel per thread. In an example, for a screen-aligned quad with magnification factor 1.0 and T=32, the bilinear filter requires no more than 54 unique texels. Hence, ≤2 texel evaluations may be sufficient to always succeed at returning a perfectly bilinearly filtered value when all pixels in a wave undergo magnification. For example, performing 2 texel evaluations per thread instead of only one texel evaluation per thread may generate substantially higher filtered quality for larger filters, such as bicubic filters. Furthermore, the fallback methods apply to modest minification filters and trilinear filtering as well, effectively performing filtering before shading.

Collaborative texture filtering offers significant advantages over conventional per-pixel or stochastic texture filtering approaches, particularly in the context of modern GPU architectures. By enabling threads within a wave to coordinate and share texel data, collaborative texture filtering minimizes redundant texel fetches and decompression operations, resulting in reduced memory bandwidth usage and lower computational overhead. This approach is especially effective during texture magnification, where overlapping filter footprints are common. Collaborative texture filtering also improves image quality by ensuring that all required texels for accurate filtering are available to each pixel, while maintaining high performance even with complex or compressed texture formats. The method is highly scalable, adaptable to various filtering modes, and well-suited for real-time applications such as gaming, virtual reality, and cloud-based rendering, where both efficiency and visual fidelity are critical.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural radiance field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Additionally, in some embodiments, the systems and methods described herein may be performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of the underlying algorithms, systems, image processing pipelines, and/or processes prior to deploying them in the real-world. In some instances, the simulation may be used to generate synthetic training data—e.g., training data including landmarks, features, objects, etc.—so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

### Parallel Processing Architecture

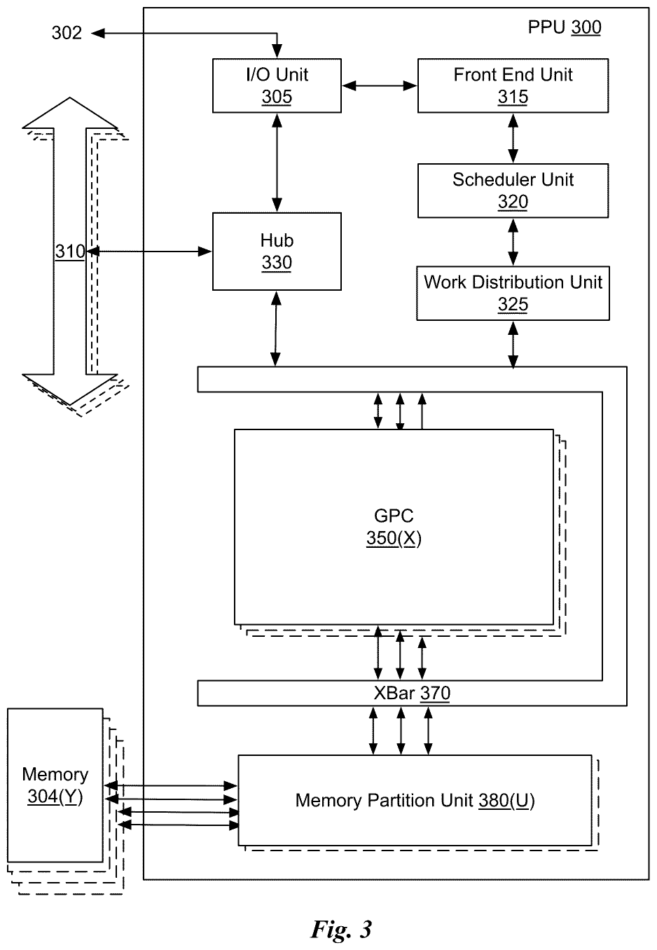

FIG. 3 illustrates a parallel processing unit (PPU) 300, in accordance with an embodiment. The PPU 300 may be used to implement the collaborative texture unit 200. The PPU 300 may be used to implement one or more of the collaborative sampling unit 210, texel storage 225, and texel combining unit 230 within the collaborative texture unit 200. In an embodiment, a processor such as the PPU 300 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 300 is a multi-threaded processor that is implemented on one or more integrated circuit devices. The PPU 300 is a latency hiding architecture designed to process many threads in parallel. A thread (e.g., a thread of execution) is an instantiation of a set of instructions configured to be executed by the PPU 300. In an embodiment, the PPU 300 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 300 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 300 may be configured to accelerate thousands of High Performance Computing (HPC), data center, cloud computing, and machine learning applications. The PPU 300 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 3, the PPU 300 includes an Input/Output (I/O) unit 305, a front end unit 315, a scheduler unit 320, a work distribution unit 325, a hub 330, a crossbar (Xbar) 370, one or more general processing clusters (GPCs) 350, and one or more memory partition units 380. The PPU 300 may be connected to a host processor or other PPUs 300 via one or more high-speed NVLink 310 interconnect. The PPU 300 may be connected to a host processor or other peripheral devices via an interconnect 302. The PPU 300 may also be connected to a local memory 304 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

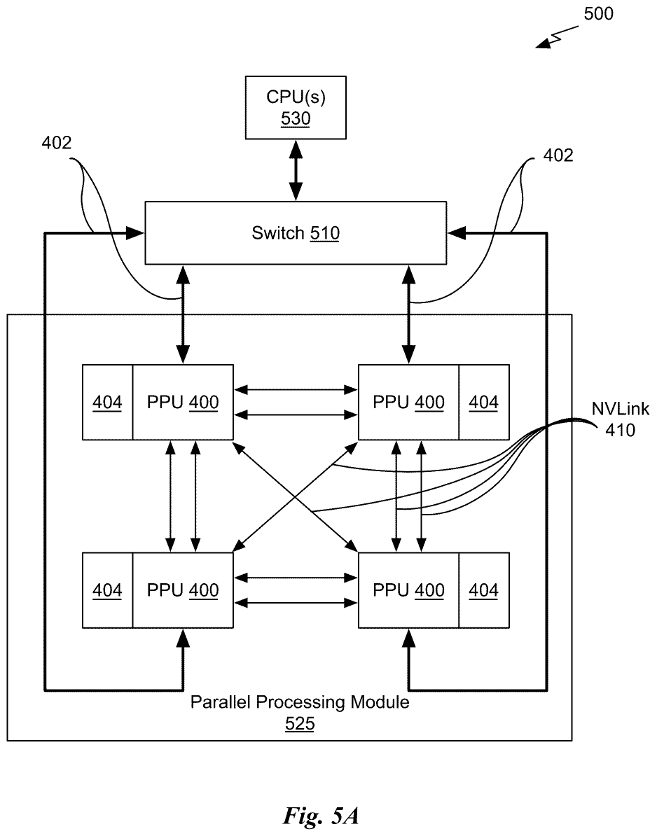

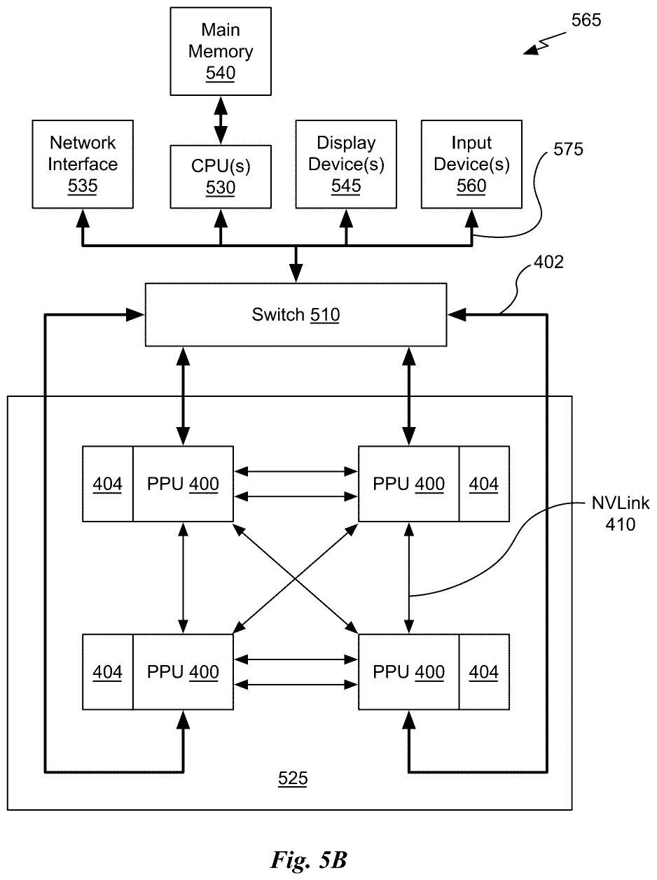

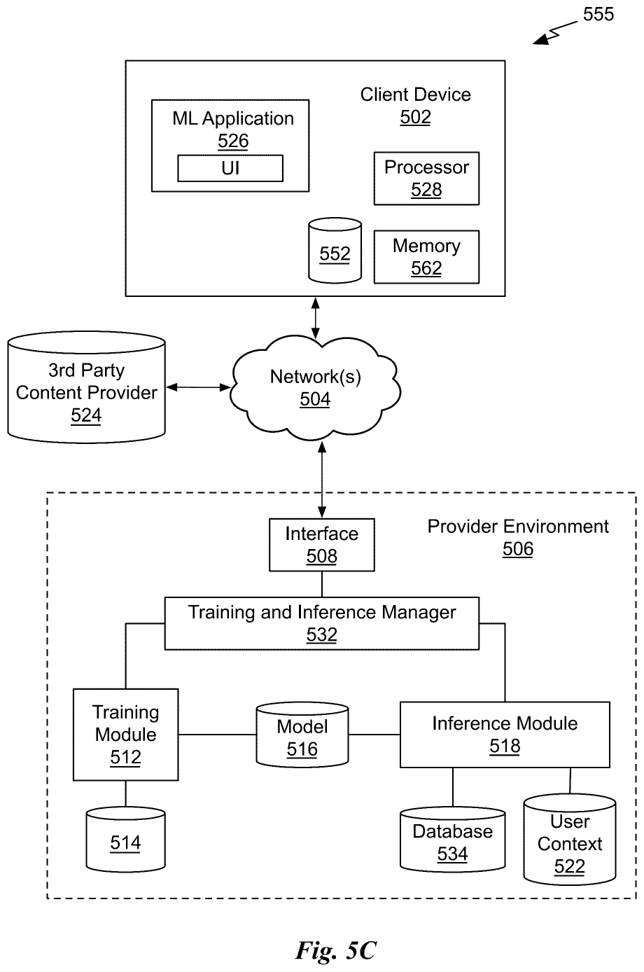

The NVLink 310 interconnect enables systems to scale and include one or more PPUs 300 combined with one or more CPUs, supports cache coherence between the PPUs 300 and CPUs, and CPU mastering. Data and/or commands may be transmitted by the NVLink 310 through the hub 330 to/from other units of the PPU 300 such as one or more copy engines, a video encoder, a video decoder, a power management unit, etc. (not explicitly shown). The NVLink 310 is described in more detail in conjunction with FIG. 5A.

The I/O unit 305 is configured to transmit and receive communications (e.g., commands, data, etc.) from a host processor (not shown) over the interconnect 302. The I/O unit 305 may communicate with the host processor directly via the interconnect 302 or through one or more intermediate devices such as a memory bridge. In an embodiment, the I/O unit 305 may communicate with one or more other processors, such as one or more the PPUs 300 via the interconnect 302. In an embodiment, the I/O unit 305 implements a Peripheral Component Interconnect Express (PCIe) interface for communications over a PCIe bus and the interconnect 302 is a PCIe bus. In alternative embodiments, the I/O unit 305 may implement other types of well-known interfaces for communicating with external devices.

The I/O unit 305 decodes packets received via the interconnect 302. In an embodiment, the packets represent commands configured to cause the PPU 300 to perform various operations. The I/O unit 305 transmits the decoded commands to various other units of the PPU 300 as the commands may specify. For example, some commands may be transmitted to the front end unit 315. Other commands may be transmitted to the hub 330 or other units of the PPU 300 such as one or more copy engines, a video encoder, a video decoder, a power management unit, etc. (not explicitly shown). In other words, the I/O unit 305 is configured to route communications between and among the various logical units of the PPU 300.

In an embodiment, a program executed by the host processor encodes a command stream in a buffer that provides workloads to the PPU 300 for processing. A workload may comprise several instructions and data to be processed by those instructions. The buffer is a region in a memory that is accessible (e.g., read/write) by both the host processor and the PPU 300. For example, the I/O unit 305 may be configured to access the buffer in a system memory connected to the interconnect 302 via memory requests transmitted over the interconnect 302. In an embodiment, the host processor writes the command stream to the buffer and then transmits a pointer to the start of the command stream to the PPU 300. The front end unit 315 receives pointers to one or more command streams. The front end unit 315 manages the one or more streams, reading commands from the streams and forwarding commands to the various units of the PPU 300.

The front end unit 315 is coupled to a scheduler unit 320 that configures the various GPCs 350 to process tasks defined by the one or more streams. The scheduler unit 320 is configured to track state information related to the various tasks managed by the scheduler unit 320. The state may indicate which GPC 350 a task is assigned to, whether the task is active or inactive, a priority level associated with the task, and so forth. The scheduler unit 320 manages the execution of a plurality of tasks on the one or more GPCs 350.

The scheduler unit 320 is coupled to a work distribution unit 325 that is configured to dispatch tasks for execution on the GPCs 350. The work distribution unit 325 may track a number of scheduled tasks received from the scheduler unit 320. In an embodiment, the work distribution unit 325 manages a pending task pool and an active task pool for each of the GPCs 350. The pending task pool may comprise a number of slots (e.g., 32 slots) that contain tasks assigned to be processed by a particular GPC 350. The active task pool may comprise a number of slots (e.g., 4 slots) for tasks that are actively being processed by the GPCs 350. As a GPC 350 finishes the execution of a task, that task is evicted from the active task pool for the GPC 350 and one of the other tasks from the pending task pool is selected and scheduled for execution on the GPC 350. If an active task has been idle on the GPC 350, such as while waiting for a data dependency to be resolved, then the active task may be evicted from the GPC 350 and returned to the pending task pool while another task in the pending task pool is selected and scheduled for execution on the GPC 350.

The work distribution unit 325 communicates with the one or more GPCs 350 via XBar 370. The XBar 370 is an interconnect network that couples many of the units of the PPU 300 to other units of the PPU 300. For example, the XBar 370 may be configured to couple the work distribution unit 325 to a particular GPC 350. Although not shown explicitly, one or more other units of the PPU 300 may also be connected to the XBar 370 via the hub 330.

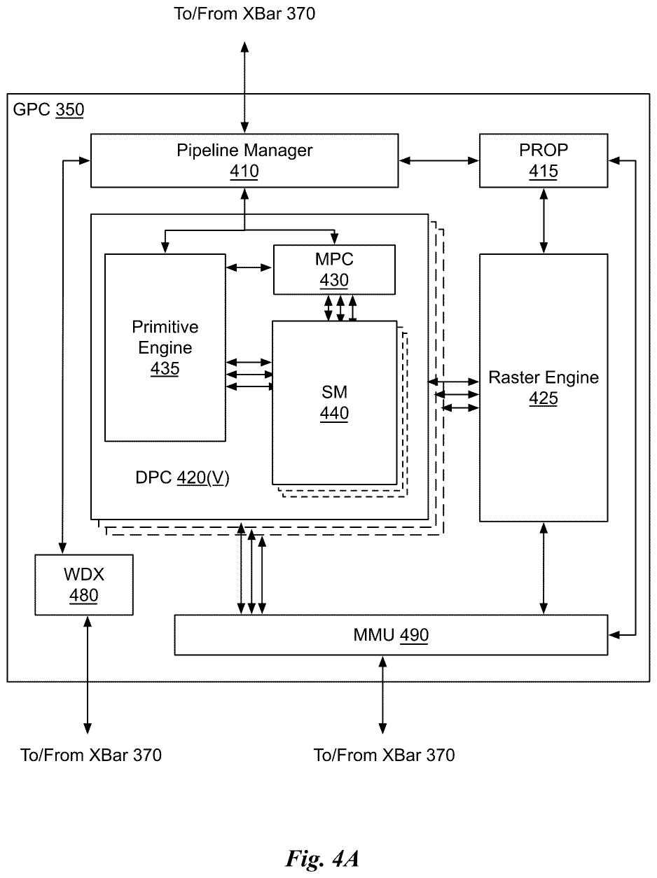

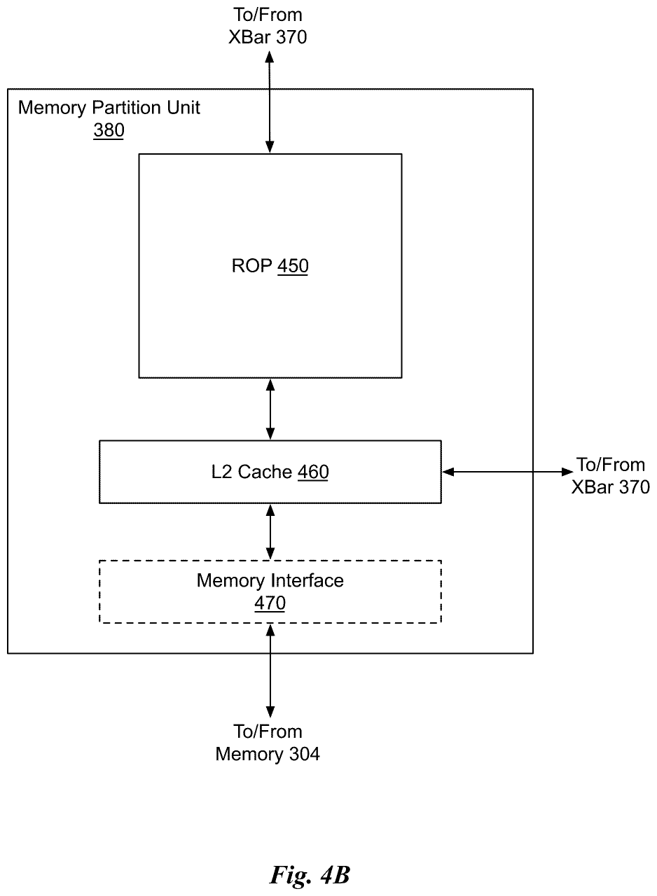

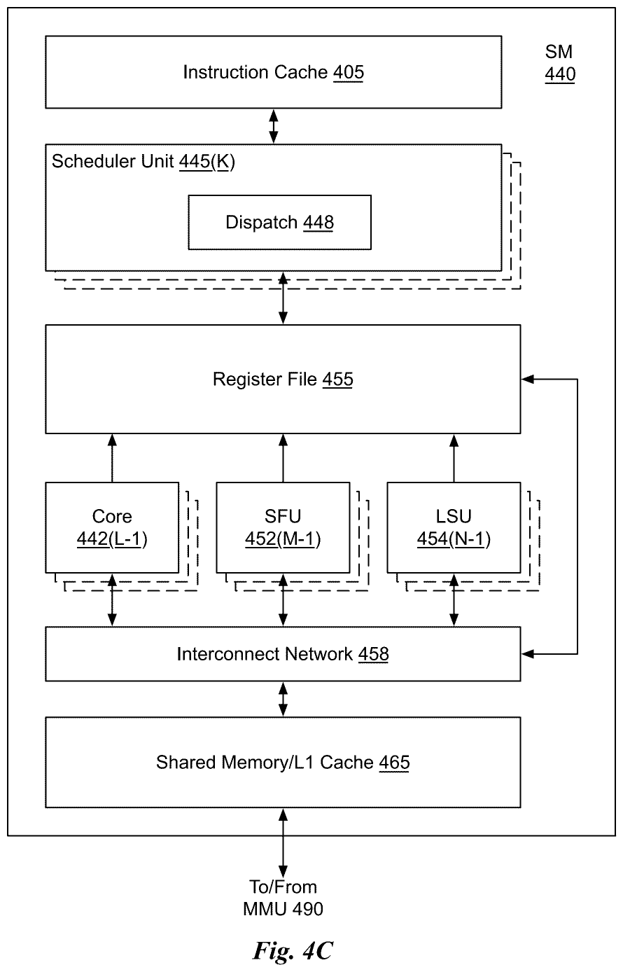

The tasks are managed by the scheduler unit 320 and dispatched to a GPC 350 by the work distribution unit 325. The GPC 350 is configured to process the task and generate results. The results may be consumed by other tasks within the GPC 350, routed to a different GPC 350 via the XBar 370, or stored in the memory 304. The results can be written to the memory 304 via the memory partition units 380, which implement a memory interface for reading and writing data to/from the memory 304. The results can be transmitted to another PPU 300 or CPU via the NVLink 310. In an embodiment, the PPU 300 includes a number U of memory partition units 380 that is equal to the number of separate and distinct memory devices of the memory 304 coupled to the PPU 300. A memory partition unit 380 will be described in more detail below in conjunction with FIG. 4B.

In an embodiment, a host processor executes a driver kernel that implements an application programming interface (API) that enables one or more applications executing on the host processor to schedule operations for execution on the PPU 300. In an embodiment, multiple compute applications are simultaneously executed by the PPU 300 and the PPU 300 provides isolation, quality of service (QoS), and independent address spaces for the multiple compute applications. An application may generate instructions (e.g., API calls) that cause the driver kernel to generate one or more tasks for execution by the PPU 300. The driver kernel outputs tasks to one or more streams being processed by the PPU 300. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 4C.

FIG. 4A illustrates a GPC 350 of the PPU 300 of FIG. 3, in accordance with an embodiment. As shown in FIG. 4A, each GPC 350 includes a number of hardware units for processing tasks. In an embodiment, each GPC 350 includes a pipeline manager 410, a pre-raster operations unit (PROP) 415, a raster engine 425, a work distribution crossbar (WDX) 480, a memory management unit (MMU) 490, and one or more Data Processing Clusters (DPCs) 420. It will be appreciated that the GPC 350 of FIG. 4A may include other hardware units in lieu of or in addition to the units shown in FIG. 4A.

In an embodiment, the operation of the GPC 350 is controlled by the pipeline manager 410. The pipeline manager 410 manages the configuration of the one or more DPCs 420 for processing tasks allocated to the GPC 350. In an embodiment, the pipeline manager 410 may configure at least one of the one or more DPCs 420 to implement at least a portion of a graphics rendering pipeline. For example, a DPC 420 may be configured to execute a vertex shader program on the programmable streaming multiprocessor (SM) 440. The pipeline manager 410 may also be configured to route packets received from the work distribution unit 325 to the appropriate logical units within the GPC 350. For example, some packets may be routed to fixed function hardware units in the PROP 415 and/or raster engine 425 while other packets may be routed to the DPCs 420 for processing by the primitive engine 435 or the SM 440. In an embodiment, the pipeline manager 410 may configure at least one of the one or more DPCs 420 to implement a neural network model and/or a computing pipeline.

The PROP unit 415 is configured to route data generated by the raster engine 425 and the DPCs 420 to a Raster Operations (ROP) unit, described in more detail in conjunction with FIG. 4B. The PROP unit 415 may also be configured to perform optimizations for color blending, organize pixel data, perform address translations, and the like.

The raster engine 425 includes a number of fixed function hardware units configured to perform various raster operations. In an embodiment, the raster engine 425 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 425 comprises fragments to be processed, for example, by a fragment shader implemented within a DPC 420.

Each DPC 420 included in the GPC 350 includes an M-Pipe Controller (MPC) 430, a primitive engine 435, and one or more SMs 440. The MPC 430 controls the operation of the DPC 420, routing packets received from the pipeline manager 410 to the appropriate units in the DPC 420. For example, packets associated with a vertex may be routed to the primitive engine 435, which is configured to fetch vertex attributes associated with the vertex from the memory 304. In contrast, packets associated with a shader program may be transmitted to the SM 440.

The SM 440 comprises a programmable streaming processor that is configured to process tasks represented by a number of threads. Each SM 440 is multi-threaded and configured to execute a plurality of threads (e.g., 32 threads) from a particular group of threads concurrently. In an embodiment, the SM 440 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 440 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 440 will be described in more detail below in conjunction with FIG. 4C.

The MMU 490 provides an interface between the GPC 350 and the memory partition unit 380. The MMU 490 may provide translation of virtual addresses into physical addresses, memory protection, and arbitration of memory requests. In an embodiment, the MMU 490 provides one or more translation lookaside buffers (TLBs) for performing translation of virtual addresses into physical addresses in the memory 304.

FIG. 4B illustrates a memory partition unit 380 of the PPU 300 of FIG. 3, in accordance with an embodiment. As shown in FIG. 4B, the memory partition unit 380 includes a Raster Operations (ROP) unit 450, a level two (L2) cache 460, and a memory interface 470. The memory interface 470 is coupled to the memory 304. Memory interface 470 may implement 32, 64, 128, 1024-bit data buses, or the like, for high-speed data transfer. In an embodiment, the PPU 300 incorporates U memory interfaces 470, one memory interface 470 per pair of memory partition units 380, where each pair of memory partition units 380 is connected to a corresponding memory device of the memory 304. For example, PPU 300 may be connected to up to Y memory devices, such as high bandwidth memory stacks or graphics double-data-rate, version 5, synchronous dynamic random access memory, or other types of persistent storage.

In an embodiment, the memory interface 470 implements an HBM2 memory interface and Y equals half U. In an embodiment, the HBM2 memory stacks are located on the same physical package as the PPU 300, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 304 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 300 process very large datasets and/or run applications for extended periods.

In an embodiment, the PPU 300 implements a multi-level memory hierarchy. In an embodiment, the memory partition unit 380 supports a unified memory to provide a single unified virtual address space for CPU and PPU 300 memory, enabling data sharing between virtual memory systems. In an embodiment the frequency of accesses by a PPU 300 to memory located on other processors is traced to ensure that memory pages are moved to the physical memory of the PPU 300 that is accessing the pages more frequently. In an embodiment, the NVLink 310 supports address translation services allowing the PPU 300 to directly access a CPU's page tables and providing full access to CPU memory by the PPU 300.

In an embodiment, copy engines transfer data between multiple PPUs 300 or between PPUs 300 and CPUs. The copy engines can generate page faults for addresses that are not mapped into the page tables. The memory partition unit 380 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 304 or other system memory may be fetched by the memory partition unit 380 and stored in the L2 cache 460, which is located on-chip and is shared between the various GPCs 350. As shown, each memory partition unit 380 includes a portion of the L2 cache 460 associated with a corresponding memory 304. Lower level caches may then be implemented in various units within the GPCs 350. For example, each of the SMs 440 may implement a level one (L1) cache. The L1 cache is private memory that is dedicated to a particular SM 440. Data from the L2 cache 460 may be fetched and stored in each of the L1 caches for processing in the functional units of the SMs 440. The L2 cache 460 is coupled to the memory interface 470 and the XBar 370.

The ROP unit 450 performs graphics raster operations related to pixel color, such as color compression, pixel blending, and the like. The ROP unit 450 also implements depth testing in conjunction with the raster engine 425, receiving a depth for a sample location associated with a pixel fragment from the culling engine of the raster engine 425. The depth is tested against a corresponding depth in a depth buffer for a sample location associated with the fragment. If the fragment passes the depth test for the sample location, then the ROP unit 450 updates the depth buffer and transmits a result of the depth test to the raster engine 425. It will be appreciated that the number of memory partition units 380 may be different than the number of GPCs 350 and, therefore, each ROP unit 450 may be coupled to each of the GPCs 350. The ROP unit 450 tracks packets received from the different GPCs 350 and determines which GPC 350 that a result generated by the ROP unit 450 is routed to through the Xbar 370. Although the ROP unit 450 is included within the memory partition unit 380 in FIG. 4B, in other embodiment, the ROP unit 450 may be outside of the memory partition unit 380. For example, the ROP unit 450 may reside in the GPC 350 or another unit.

FIG. 4C illustrates the streaming multi-processor 440 of FIG. 4A, in accordance with an embodiment. As shown in FIG. 4C, the SM 440 includes an instruction cache 405, one or more (K) scheduler units 445, a register file 455, one or more processing cores 442, one or more special function units (SFUs) 452, one or more load/store units (LSUs) 454, an interconnect network 458, a shared memory/L1 cache 465.

As described above, the work distribution unit 325 dispatches tasks for execution on the GPCs 350 of the PPU 300. The tasks are allocated to a particular DPC 420 within a GPC 350 and, if the task is associated with a shader program, the task may be allocated to an SM 440. The scheduler unit 445 receives the tasks from the work distribution unit 325 and manages instruction scheduling for one or more thread blocks assigned to the SM 440. The scheduler unit 445 schedules thread blocks for execution as warps of parallel threads, where each thread block is allocated at least one warp. In an embodiment, each warp executes 32 threads. The scheduler unit 445 may manage a plurality of different thread blocks, allocating the warps to the different thread blocks and then dispatching instructions from the plurality of different cooperative groups to the various functional units (e.g., cores 442, SFUs 452, and LSUs 454) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 448 is configured to transmit instructions to one or more of the functional units. In the embodiment, the scheduler unit 445 includes two dispatch units 448 that enable two different instructions from the same warp to be dispatched during each clock cycle. In alternative embodiments, each scheduler unit 445 may include a single dispatch unit 448 or additional dispatch units 448.

Each SM 440 includes a register file 455 that provides a set of registers for the functional units of the SM 440. In an embodiment, the register file 455 is divided between each of the functional units such that each functional unit is allocated a dedicated portion of the register file 455. In another embodiment, the register file 455 is divided between the different warps being executed by the SM 440. The register file 455 provides temporary storage for operands connected to the data paths of the functional units.

Each SM 440 comprises L processing cores 442. In an embodiment, the SM 440 includes a large number (e.g., 128, etc.) of distinct processing cores 442. Each core 442 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 442 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 442. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 440 also comprises M SFUs 452 that perform special functions (e.g., attribute evaluation, reciprocal square root, and the like). In an embodiment, the SFUs 452 may include a tree traversal unit configured to traverse a hierarchical tree data structure. In an embodiment, the SFUs 452 may include texture unit configured to perform texture map filtering operations. In an embodiment, the texture units are configured to load texture maps (e.g., a 2D array of texels) from the memory 304 and sample the texture maps to produce sampled texture values for use in shader programs executed by the SM 440. In an embodiment, the texture maps are stored in the shared memory/L1 cache 465. The texture units implement texture operations such as filtering operations using mip-maps (e.g., texture maps of varying levels of detail). In an embodiment, each SM 340 includes two texture units.

Each SM 440 also comprises N LSUs 454 that implement load and store operations between the shared memory/L1 cache 465 and the register file 455. Each SM 440 includes an interconnect network 458 that connects each of the functional units to the register file 455 and the shared memory/L1 cache 465. In an embodiment, the interconnect network 458 is a crossbar that can be configured to connect any of the functional units to any of the registers in the register file 455 and memory locations in shared memory/L1 cache 465.

In an embodiment, the SFUs 452 are configured to perform stochastic texture filtering. In an embodiment, in response to a first instruction, a single texel value is returned from a block-compressed texture map. In an embodiment, a second instruction dequantizes texels (e.g., 8-bit to float32, or from a 5-6-5 bit RGB format to float32s). In an embodiment, a third instruction performs sRGB texture decoding. In an embodiment, a fourth instruction computes a texture level of detail given texture coordinate derivatives. In an embodiment, a fifth instruction selects a cube map face and texture coordinates given a 3D direction vector. In an embodiment, the LSUs 454 support fetching and decoding tightly packed and quantized “texels” (e.g., 2 bit or 4 bit, etc.), which might be used as texture representation by custom compressed texture formats (enabled by stochastic filtering), including but not limited to new compression formats using neural networks. In an embodiment, in response to executing a single instruction, the SM 440 causes quantized latent representations (e.g., neural textures) to be fetched and decoded, with the decoded representations sent to an independent Tensor unit or the cores 442, for processing. In an embodiment, a sixth instruction performs stochastic bilinear filtering by taking the (s,t) texture coordinates and a random sample in [0,1] and returning integer (s,t) coordinates sampled stochastically.

The shared memory/L1 cache 465 is an array of on-chip memory that allows for data storage and communication between the SM 440 and the primitive engine 435 and between threads in the SM 440. In an embodiment, the shared memory/L1 cache 465 comprises 128 KB of storage capacity and is in the path from the SM 440 to the memory partition unit 380. The shared memory/L1 cache 465 can be used to cache reads and writes. One or more of the shared memory/L1 cache 465, L2 cache 460, and memory 304 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 465 enables the shared memory/L1 cache 465 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 3, are bypassed, creating a much simpler programming model. In the general purpose parallel computation configuration, the work distribution unit 325 assigns and distributes blocks of threads directly to the DPCs 420. The threads in a block execute the same program, using a unique thread ID in the calculation to ensure each thread generates unique results, using the SM 440 to execute the program and perform calculations, shared memory/L1 cache 465 to communicate between threads, and the LSU 454 to read and write global memory through the shared memory/L1 cache 465 and the memory partition unit 380. When configured for general purpose parallel computation, the SM 440 can also write commands that the scheduler unit 320 can use to launch new work on the DPCs 420.

The PPU 300 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 300 is embodied on a single semiconductor substrate. In another embodiment, the PPU 300 is included in a system-on-a-chip (SoC) along with one or more other devices such as additional PPUs 300, the memory 304, a reduced instruction set computer (RISC) CPU, a memory management unit (MMU), a digital-to-analog converter (DAC), and the like.

In an embodiment, the PPU 300 may be included on a graphics card that includes one or more memory devices. The graphics card may be configured to interface with a PCIe slot on a motherboard of a desktop computer. In yet another embodiment, the PPU 300 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 500 may be configured to implement the method 250 shown in FIG. 2D. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the method 250 shown in FIG. 2D.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

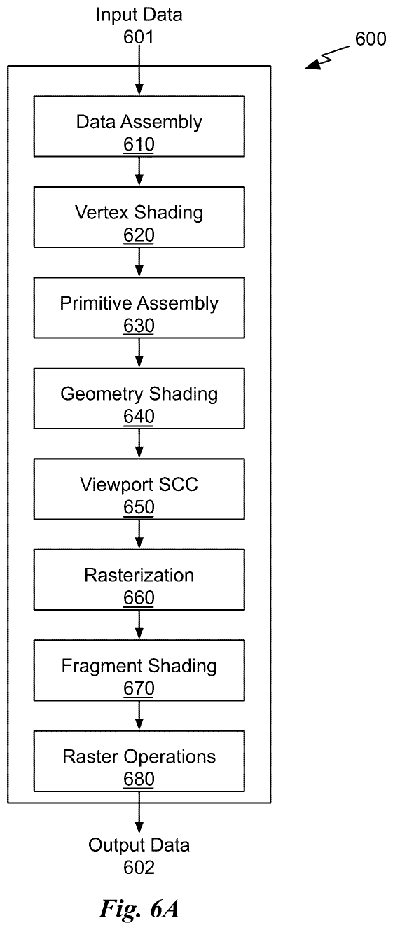

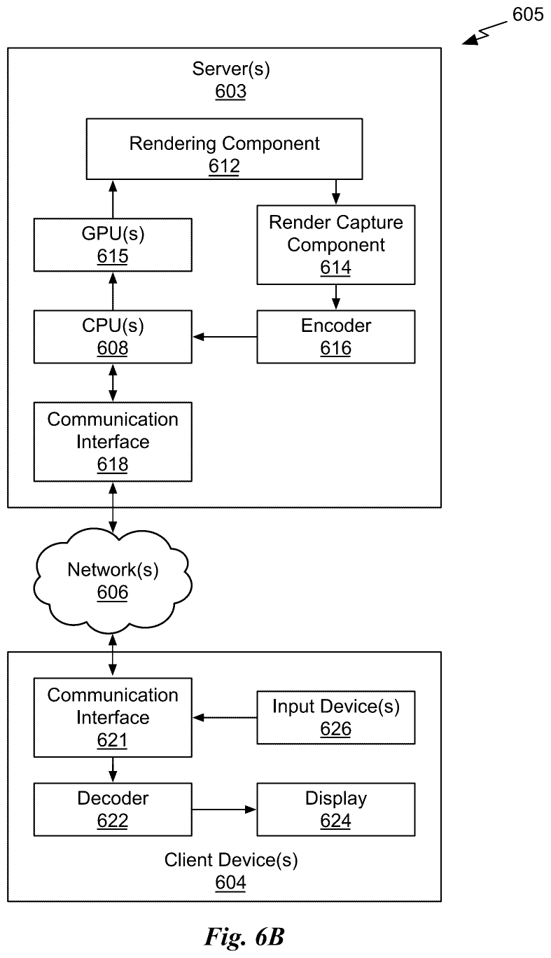

FIG. 6A is a conceptual diagram of a graphics processing pipeline 600 implemented by the PPU 400 of FIG. 4, in accordance with an embodiment. The graphics processing pipeline 600 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 600 receives input data 601 that is transmitted from one stage to the next stage of the graphics processing pipeline 600 to generate output data 602. In an embodiment, the graphics processing pipeline 600 may represent a graphics processing pipeline defined by the OpenGL® API. As an option, the graphics processing pipeline 600 may be implemented in the context of the functionality and architecture of the previous Figures and/or any subsequent Figure(s).

As shown in FIG. 6A, the graphics processing pipeline 600 comprises a pipeline architecture that includes a number of stages. The stages include, but are not limited to, a data assembly stage 610, a vertex shading stage 620, a primitive assembly stage 630, a geometry shading stage 640, a viewport scale, cull, and clip (VSCC) stage 650, a rasterization stage 660, a fragment shading stage 670, and a raster operations stage 680. In an embodiment, the input data 601 comprises commands that configure the processing units to implement the stages of the graphics processing pipeline 600 and geometric primitives (e.g., points, lines, triangles, quads, triangle strips or fans, etc.) to be processed by the stages. The output data 602 may comprise pixel data (e.g., color data) that is copied into a frame buffer or other type of surface data structure in a memory.

The data assembly stage 610 receives the input data 601 that specifies vertex data for high-order surfaces, primitives, or the like. The data assembly stage 610 collects the vertex data in a temporary storage or queue, such as by receiving a command from the host processor that includes a pointer to a buffer in memory and reading the vertex data from the buffer. The vertex data is then transmitted to the vertex shading stage 620 for processing.

The vertex shading stage 620 processes vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading stage 620 may manipulate individual vertex attributes such as position, color, texture coordinates, and the like. In other words, the vertex shading stage 620 performs operations on the vertex coordinates or other vertex attributes associated with a vertex. Such operations commonly including lighting operations (e.g., modifying color attributes for a vertex) and transformation operations (e.g., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading stage 620 generates transformed vertex data that is transmitted to the primitive assembly stage 630.

The primitive assembly stage 630 collects vertices output by the vertex shading stage 620 and groups the vertices into geometric primitives for processing by the geometry shading stage 640. For example, the primitive assembly stage 630 may be configured to group every three consecutive vertices as a geometric primitive (e.g., a triangle) for transmission to the geometry shading stage 640. In some embodiments, specific vertices may be reused for consecutive geometric primitives (e.g., two consecutive triangles in a triangle strip may share two vertices). The primitive assembly stage 630 transmits geometric primitives (e.g., a collection of associated vertices) to the geometry shading stage 640.

The geometry shading stage 640 processes geometric primitives by performing a set of operations (e.g., a geometry shader or program) on the geometric primitives. Tessellation operations may generate one or more geometric primitives from each geometric primitive. In other words, the geometry shading stage 640 may subdivide each geometric primitive into a finer mesh of two or more geometric primitives for processing by the rest of the graphics processing pipeline 600. The geometry shading stage 640 transmits geometric primitives to the viewport SCC stage 650.

In an embodiment, the graphics processing pipeline 600 may operate within a streaming multiprocessor and the vertex shading stage 620, the primitive assembly stage 630, the geometry shading stage 640, the fragment shading stage 670, and/or hardware/software associated therewith, may sequentially perform processing operations. Once the sequential processing operations are complete, in an embodiment, the viewport SCC stage 650 may utilize the data. In an embodiment, primitive data processed by one or more of the stages in the graphics processing pipeline 600 may be written to a cache (e.g. L1 cache, a vertex cache, etc.). In this case, in an embodiment, the viewport SCC stage 650 may access the data in the cache. In an embodiment, the viewport SCC stage 650 and the rasterization stage 660 are implemented as fixed function circuitry.

The viewport SCC stage 650 performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum. Furthermore, geometric primitives may each be scaled based on a depth of the viewing frustum. All potentially visible geometric primitives are then transmitted to the rasterization stage 660.

The rasterization stage 660 converts the 3D geometric primitives into 2D fragments (e.g. capable of being utilized for display, etc.). The rasterization stage 660 may be configured to utilize the vertices of the geometric primitives to setup a set of plane equations from which various attributes can be interpolated. The rasterization stage 660 may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization stage 660 generates fragment data (e.g., interpolated vertex attributes associated with a particular sample location for each covered pixel) that are transmitted to the fragment shading stage 670.

The fragment shading stage 670 processes fragment data by performing a set of operations (e.g., a fragment shader or a program) on each of the fragments. The fragment shading stage 670 may generate pixel data (e.g., color values) for the fragment such as by performing lighting operations or sampling texture maps using interpolated texture coordinates for the fragment. The fragment shading stage 670 generates pixel data that is transmitted to the raster operations stage 680.

The raster operations stage 680 may perform various operations on the pixel data such as performing alpha tests, stencil tests, and blending the pixel data with other pixel data corresponding to other fragments associated with the pixel. When the raster operations stage 680 has finished processing the pixel data (e.g., the output data 602), the pixel data may be written to a render target such as a frame buffer, a color buffer, or the like.

It will be appreciated that one or more additional stages may be included in the graphics processing pipeline 600 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 640). Other types of graphics processing pipelines are contemplated as being within the scope of the present disclosure. Furthermore, any of the stages of the graphics processing pipeline 600 may be implemented by one or more dedicated hardware units within a graphics processor such as PPU 400. Other stages of the graphics processing pipeline 600 may be implemented by programmable hardware units such as the processing unit within the PPU 400.

The graphics processing pipeline 600 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 400. The API provides an abstraction for a programmer that lets a programmer utilize specialized graphics hardware, such as the PPU 400, to generate the graphical data without requiring the programmer to utilize the specific instruction set for the PPU 400. The application may include an API call that is routed to the device driver for the PPU 400. The device driver interprets the API call and performs various operations to respond to the API call. In some instances, the device driver may perform operations by executing instructions on the CPU. In other instances, the device driver may perform operations, at least in part, by launching operations on the PPU 400 utilizing an input/output interface between the CPU and the PPU 400. In an embodiment, the device driver is configured to implement the graphics processing pipeline 600 utilizing the hardware of the PPU 400.

Various programs may be executed within the PPU 400 in order to implement the various stages of the graphics processing pipeline 600. For example, the device driver may launch a kernel on the PPU 400 to perform the vertex shading stage 620 on one processing unit (or multiple processing units). The device driver (or the initial kernel executed by the PPU 400) may also launch other kernels on the PPU 400 to perform other stages of the graphics processing pipeline 600, such as the geometry shading stage 640 and the fragment shading stage 670. In addition, some of the stages of the graphics processing pipeline 600 may be implemented on fixed unit hardware such as a rasterizer or a data assembler implemented within the PPU 400. It will be appreciated that results from one kernel may be processed by one or more intervening fixed function hardware units before being processed by a subsequent kernel on a processing unit.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

FIG. 6B is an example system diagram for a streaming system 605, in accordance with some embodiments of the present disclosure. FIG. 6B includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, one VPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation comprises generating one or more machine-executable instructions, operations, or other signals from source code. In at least one embodiment, an API compiled into one or more instructions, operations, or other signals, when performed, causes one or more processors such as graphics processors, graphics cores, parallel processor, processor, processor core, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method for collaborative texture filtering, comprising:
receiving texture coordinates associated with rendered geometry that intersects a plurality of pixels for processing by a wave of threads;
determining a set of texels to obtain based on the texture coordinates and a filtering mode to produce filtered texels, wherein the threads in the wave collaborate to remove at least one duplicate texel from the set of texels;
obtaining texel values for the set of texels by the threads in the wave; and
computing a set of filtered texels for the plurality of pixels using the texel values.

2. The method of claim 1, wherein each thread in the wave obtains at most one texel.

3. The method of claim 2, wherein at least one additional texel value needed by a first thread in the wave and that is obtained by a second thread in the wave is shared with the first thread to compute the set of filtered texels.

4. The method of claim 1, wherein a number of threads in the wave is greater or equal to a number of texels in the set of texels.

5. The method of claim 1, wherein the set of texels comprises texels within a bounding region defined by a texture footprint corresponding to the plurality of pixels for the filtering mode.

6. The method of claim 5, wherein the bounding region is a box defined by minimal texel coordinates and maximum texel coordinates of the texture footprint.

7. The method of claim 5, wherein the bounding region is defined by a bitmask indicating the set of texels and the bitmask is produced by combining per-thread bitmasks indicating one or more texels needed to compute one filtered texel for each pixel in the plurality of pixels.

8. The method of claim 1, wherein the determining comprises:
identifying a first thread in the wave of threads corresponding to a duplicate texel that is assigned to the first thread and at least a second thread in the wave of threads; and
assigning the first thread to a first texel in the set of texels that is not assigned to any of the threads in the wave.

9. The method of claim 1, wherein at least one missing texel that contributes to a first filtered texel in the set of filtered texels is not included in the set of texels.

10. The method of claim 9, wherein the first filtered texel is computed based on an estimated contribution of the at least one missing texel comprising an average of at least one texel value of the texel values (average of known texels).

11. The method of claim 9, wherein the determining comprises:
identifying a first thread in the wave of threads corresponding to a duplicate texel that is assigned to the first thread and at least a second thread in the wave; and
selecting to obtain, by the first thread, a second texel that contributes to the first filtered texel.

12. The method of claim 9, further comprising stochastically selecting one texel that contributes to the first filtered texel for inclusion in the set of texels.

13. The method of claim 9, further comprising selecting a texel corresponding to a highest filter weight of the first filtered texel for inclusion in the set of texels.

14. The method of claim 1, further comprising generating an invertible mapping between thread identifiers and either the texel coordinates or a wave bitmask.

15. The method of claim 14, wherein a bijective function is used to generate the invertible mapping.

16. The method of claim 1, wherein a number of threads in the wave is less than a number of texels in the set of texels.

17. The method of claim 1, wherein obtaining the texel values comprises decompressing the set of texels to compute the texel values.

18. The method of claim 17, wherein the threads decompress at least one color channel to compute the texel values.

19. The method of claim 17, wherein a number of processing passes performed by tensor cores used to decompress the set of texels is based on the number of texels in the set of texels.

20. The method of claim 1, wherein the filtering mode comprises one of bilinear, bicubic B-spline, Catmull-Rom, a cubic B-spline polynomial, Mitchell polynomial, Gaussian, parametric, or program.

21. A system, comprising:
a memory that stores texel values for a texture map; and
a processor that is connected to the memory, wherein the processor is configured to perform collaborative texture filtering by:
receiving texture coordinates associated with rendered geometry that intersects a plurality of pixels for processing by a wave of threads;
determining a set of texels to obtain based on the texture coordinates and a filtering mode to produce filtered texels, wherein the threads in the wave collaborate to remove at least one duplicate texel from the set of texels;
obtaining texel values for the set of texels by the threads in the wave; and
computing a set of filtered texels for the plurality of pixels using the texel values.

22. The system of claim 21, wherein the determining comprises:
identifying a first thread in the wave of threads corresponding to a duplicate texel that is assigned to the first thread and at least a second thread in the wave of threads; and
assigning the first thread to a first texel in the set of texels that is not assigned to any of the threads in the wave.

23. The system of claim 21, wherein system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets;
a system implemented at least partially using cloud computing resources;
a system using or deploying one or more inference microservices; or
a system that incorporates one or more machine learning models deployed in a service or microservice along with an OS-level virtualization package (e.g., a container).

24. A non-transitory computer-readable media storing computer instructions for collaborative texture filtering that, when executed by one or more processors, cause the one or more processors to perform the steps of:
receiving texture coordinates associated with rendered geometry that intersects a plurality of pixels for processing by a wave of threads;
determining a set of texels to obtain based on the texture coordinates and a filtering mode to produce filtered texels, wherein the threads in the wave collaborate to remove at least one duplicate texel from the set of texels;
obtaining texel values for the set of texels by the threads in the wave; and
computing a set of filtered texels for the plurality of pixels using the texel values.

25. The non-transitory computer-readable media of claim 24, wherein each thread in the wave obtains at most one texel.
